(19) United States
(12) Patent Application Publication
(10) Pub. No.: US 2014/0198802 A1
(43) Pub. Date: Jul. 17, 2014

(54) METHOD TO SELECTIVELY ADD PRIORITY TAGGING TO NETWORK TRAFFIC

(71) Applicants: David John Weaver, Fishers, IN (US); Keith Robert Broerman, Carmel, IN (US); Martin Vincent Davey, Indianapolis, IN (US)

(72) Inventors: David John Weaver, Fishers, IN (US); Keith Robert Broerman, Carmel, IN (US); Martin Vincent Davey, Indianapolis, IN (US)

(73) Assignee: THOMSON LICENSING, Issy de Moulineaux (FR)

(21) Appl. No.: 14/237,219

(22) PCT Filed: Jan. 11, 2012
(86) PCT No.: PCT/US2012/020865

§ 371 Date: Feb. 5, 2014

Related U.S. Application Data
(60) Provisional application No. 61/521,790, filed on Aug. 10, 2011.

(51) Int. Cl. H04L 12/933

(52) U.S. Cl. CPC H04L 49/15
USPC 370/401

(57) ABSTRACT

A gateway device communicates with a client device on a local area network. The gateway device receives a dynamic host configuration protocol (DHCP) request from the client device; wherein the DHCP request includes information indicating whether, or not, the client device supports quality of service (QoS) treatment; and if the client device supports QoS treatment, the gateway device sends packets destined for the client device with QoS priority tagging information; and if the client device does not support QoS treatment, the gateway device sends packets destined for the client device without QoS priority tagging information.

### CROSS-REFERENCE TO RELATED APPLICATIONS

This application claims the benefit of U.S. Provisional Application No. 61/521,790, filed Aug. 10, 2011.

### BACKGROUND OF THE INVENTION

The present invention generally relates to communications systems and, more particularly, to networking systems, e.g., gateway devices such as, but not limited to, routers, cable modems, etc.

As devices become more and more complex and the needs of data transmission becomes more and more diverse, there is an increasing need for prioritizing the traffic that is passed through a gateway device to a client device. Voice data, for example, is time sensitive and needs to be treated as more important than file data that is downloaded as a background task to a personal computer, e.g., a laptop. As a result, a good deal of thought and research has been put into these needs that resulted in standards at the Media Access Control (MAC) layer of communication networking such as IEEE 802.1Q and IEEE 802.1p. In this regard, the IEEE 802.1Q standard adds 4 bytes of header information to data packets transmitted over networks. The 802.1Q header includes a 3-bit 802.1p field whose value designates the priority of the data in the packet, i.e., represents the required Quality of Service (QoS) treatment for this packet.

However, these additional 4 bytes of 802.1Q information are inserted between the Source Address field and the Length/Type field in the MAC frame (or packet) with the result that both the maximum MAC frame size is now greater when using 802.1Q tagging and, in addition, the location of the payload in the MAC frame is now shifted by 4 bytes. As such, a network system, e.g., a gateway device, that uses Layer 2 (L2) QoS (also can be referred to as 802.1p QoS) will now communicate MAC frames having a maximum frame size of 1522 bytes to client devices on the network. These are also referred to as Tagged Frames. In comparison, a network system that does not use L2 QoS will communicate Untagged Frames having a maximum frame size of 1518 bytes. In other words, when a network supports L2 QoS, the packet structure is different from a network that does not support L2 QoS. As such, a gateway would be configured to either include L2 QoS for all traffic or not include L2 QoS for any traffic on the network.

Unfortunately, if the gateway device is configured to support L2 QoS for all traffic on the network, a client device that does not support 802.1Q tagging (and hence, L2 QoS) may reject any received packets containing the extra bytes, may not be able to correctly recover the payload, and/or may not be able to communicate over the network. In order to work around this problem, and communicate over a network that supports L2 QoS, manual intervention is required at the client device to adjust the expected MAC frame size in order to properly locate the payload even if the client device does not support 802.1Q tagging.

### SUMMARY OF THE INVENTION

In view of the above, we have observed that the inclusion of the extra information relating to L2 QoS could greatly improve a user's experiences in a network even if some of the client devices on the network do not support 802.1Q tagging. However, we have also observed it would be beneficial if the network was still compatible to those client devices that do not support 802.1Q tagging such that these client devices do not have to manually adjust for the packet format. Therefore, and in accordance with the principles of the invention, a method comprises communicating with a client device on a Local Area Network (LAN) for determining whether, or not, Layer 2 Quality of Service (QoS) treatment is supported by the client device; and adjusting the packet, or frame size, subsequently communicated with the client device in accordance with the determined L2 QoS treatment.

In an illustrative embodiment of the invention, a gateway device communicates with a client device on a local area network. The gateway device receives a dynamic host configuration protocol (DHCP) request from the client device; wherein the DHCP request includes information indicating whether, or not, the client device supports Layer 2 quality of service (QoS) treatment; and if the client device supports L2 QoS treatment, the gateway device sends 802.1Q Tagged Frames destined for the client device with 802.1p QoS priority tagging information; and if the client device does not support L2 QoS treatment, the gateway device sends Untagged Frames destined for the client device without L2 QoS priority tagging information.

In another illustrative embodiment of the invention, a gateway device implements a general set of rules that automate which packets have the additional L2 QoS information included in their traffic. As such, the network, or gateway device, supports L2 QoS for those client devices that support L2 QoS treatment and the network, or gateway device, is still compatible with those client devices that do not support L2 QoS treatment.

In view of the above, and as will be apparent from reading the detailed description, other embodiments and features are also possible and fall within the principles of the invention.

### BRIEF DESCRIPTION OF THE DRAWINGS

FIG. 1 shows a comparison between an Ethernet Untagged Frame and an Ethernet Tagged Frame;

FIG. 2 shows in illustrative network in accordance with the principles of the invention;

FIG. 3 shows an illustrative embodiment of a gateway device in accordance with the principles of the invention;

FIG. 4 shows an illustrative flow chart for use in Broadband Home Router (BHR) 10 of FIG. 2 in accordance with the principles of the invention;

FIG. 5 shows another illustrative flow chart for use in BHR 10 of FIG. 2 in accordance with the principles of the invention;

FIG. 6 shows DHCP request option 60 in accordance with the principles of the invention;

FIGS. 7 and 8 show illustrative tables for use in BHR 10 of FIG. 2 in accordance with the principles of the invention;

FIG. 9 shows another illustrative flow chart for use in BHR 10 of FIG. 2 in accordance with the principles of the invention;

FIGS. 10, 11 and 12 show other illustrative tables for use in BHR 10 of FIG. 2 in accordance with the principles of the invention;

FIG. 13 shows another illustrative flow chart for use in BHR 10 of FIG. 2 in accordance with the principles of the invention; and

FIG. 14 shows 802.1Q Tagging Field 110 of FIG. 1 for use in accordance with the principles of the invention.

### DETAILED DESCRIPTION

Other than the inventive concept, the elements shown in the figures are well known and will not be described in detail. For example, other than the inventive concept, familiarity with networking such as, e.g., the Transmission Control Protocol (TCP) and the User Datagram Protocol (UDP) is assumed and not described herein. In this regard, familiarity with the standards and recommended practices of IEEE 802.1, such as, e.g., IEEE 802.1Q and IEEE 802.1p, is assumed and not described herein. Likewise, familiarity with the Dynamic Host Configuration Protocol (DHCP) is assumed and not described here (e.g., see Request for Comment (RFC) 2132, Network Working Group, “DHCP Options and BOOTP Vendor Extensions”, March 1997). It should also be noted that the inventive concept may be implemented using conventional programming techniques, which, as such, will not be described herein. Finally, like-numbers on the figures represent similar elements.

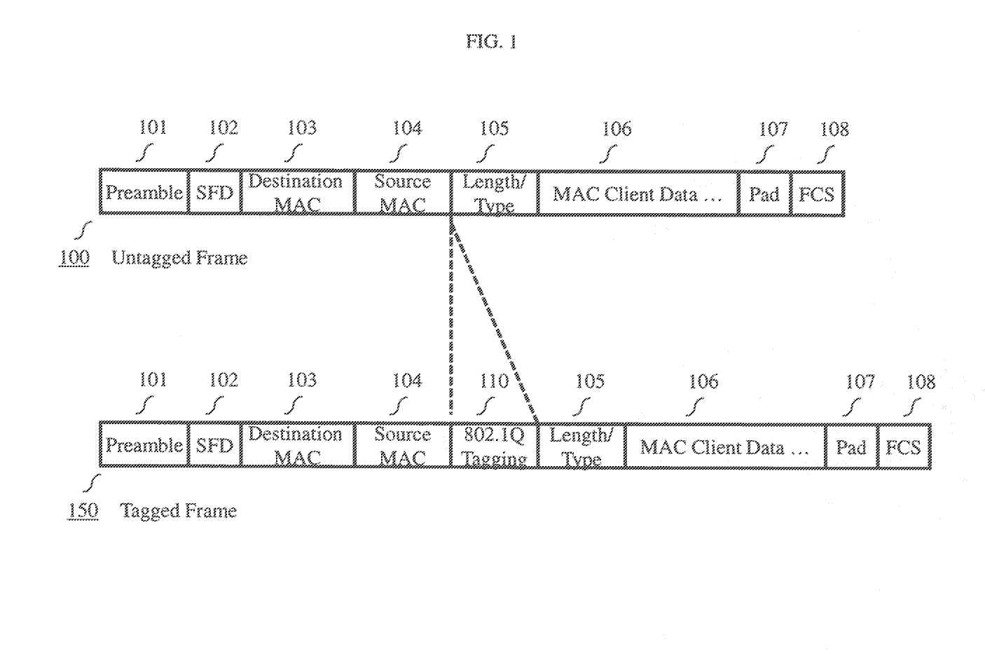

As noted earlier, the IEEE 802.1Q standard adds 4 bytes of header information to data packets transmitted over networks. The 802.1Q header includes a 3-bit 802.1p field to designate the priority of the data in the packet, i.e., represents the required Quality of Service (QoS) treatment for this packet. These 4 header bytes are inserted between the Source Address field and the Length/Type field in the MAC frame (or packet) with the result that both the maximum MAC frame size is now greater when using 802.1Q tagging then when not using 802.1Q tagging. This is illustrated in FIG. 1, which compares the packet structure for an Ethernet Untagged Frame 100 (without 802.1Q tagging) and an Ethernet Tagged Frame 150 (with 802.1Q tagging). Ethernet Untagged Frame 100 as defined, e.g., in IEEE 802.3, comprises a Preamble field 101 (7 bytes), a Start Frame Delimiter (SFD) field 102 (1 byte), a Destination MAC address field 103 (6 bytes), a Source MAC address field 104 (6 bytes), a Length/Type field 105 (2 bytes), a MAC Client Data field 106 (minimum size is 64 bytes, maximum size 1500 bytes), a PAD field 107 (if necessary to bring the MAC Client

Data field up to its minimum size of 64 bytes), and a Frame Check Sequence (FCS) field 108 (4 bytes). In comparison, Ethernet Tagged Frame 150 as defined, e.g., in IEEE 802.3ac, adds the 802.1Q field, 110 (4 bytes) between the Source MAC address field 104 and the Length/Type field 105. As such, when a network supports L2 QoS, the packet structure is different from a network that does not support L2 QoS such that an additional field is included and the payload is actually shifted by 4 bytes.

Unfortunately, if the gateway device is configured to support L2 QoS for all traffic on the network, a client device that does not support 802.1Q tagging (and hence Layer 2 QoS) may reject any received packets 150 containing the extra bytes, may not be able to correctly recover the payload, and/or may not be able to communicate over the network. In order to work around this problem, and communicate over a network that supports L2 QoS, manual intervention is required at the client device to adjust the received MAC frame size in order to properly locate the payload even if the client device does not support 802.1Q tagging.

In view of the above, we have observed that the inclusion of the 802.1Q field 110 relating to QoS could greatly improve a user's experiences in a network even if some of the client devices on the network do not support L2 QoS treatment. However, we have also observed it would be beneficial if the network was still compatible to those client devices that do not support L2 QoS treatment such that the client devices do not have to manually adjust for the different packet structure. Therefore, and in accordance with the principles of the invention, a method comprises establishing communication with devices on a Local Area Network (LAN), determining whether or not Layer 2 Quality of Service (QoS) treatment is supported by each device, and adjusting the packet, or frame size, communicated with each device in accordance with the determined L2 QoS treatment.

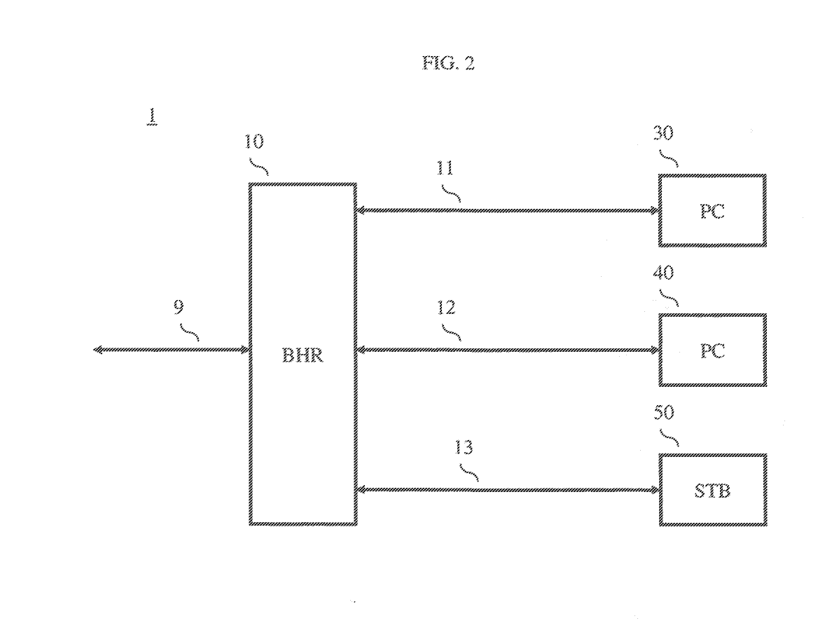

FIG. 2 shows an illustrative network system in accordance with the principles of the invention. A LAN 1 comprises a gateway device, e.g., Broadband Home Router (BHR) 10, and a number of client devices: a personal computer (PC) 30, a PC 40 and a set top box (STB) 50. Each client device is connected to a LAN port of BHR 10 via a wired, or wireless, connection as represented by arrows 11, 12 and 13. BHR 10 is also connected to a network cloud (not shown) via, e.g., a wired, or wireless, connection as represented by arrow 9 for sending and receiving data, such as internet protocol (IP) packets to, and from, other servers and endpoints. It should be noted that a client device is not limited to the PC and STB illustrated in FIG. 1. Other client devices are possible such as, but not limited to, Ipads, Ipods, cellphones, Televisions, printers, etc. Likewise, a gateway device is not limited to the BHR of FIG. 1 and can also be, e.g., a cable modem, etc. In addition, other routers, or bridges (wired or wireless), may hang off of LAN 1 for networking other STBs and PCs.

In accordance with the principles of the invention, a gateway device implements a general set of rules that automate which packets have the additional L2 QoS information included in their traffic. In other words, as a client device connects to a LAN interface, rules govern whether, or not, priority tagging information is added to, or removed from, traffic by the gateway device that goes to, or comes from, that specific client device. As such, the network, or gateway device, supports L2 QoS for those client devices that support L2 QoS treatment and the network, or gateway device, is still compatible with those client devices that do not support L2 QoS treatment.

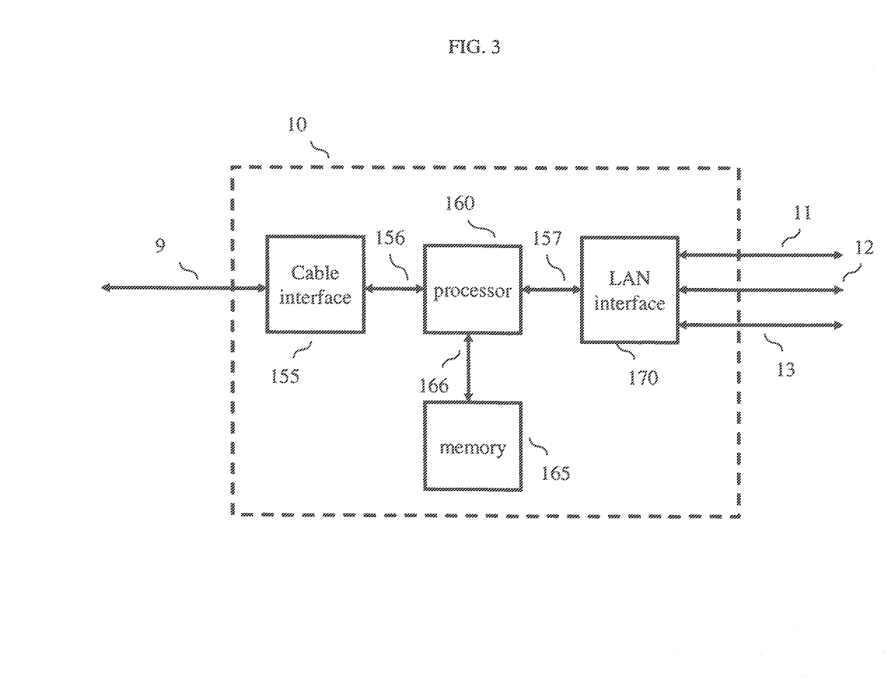

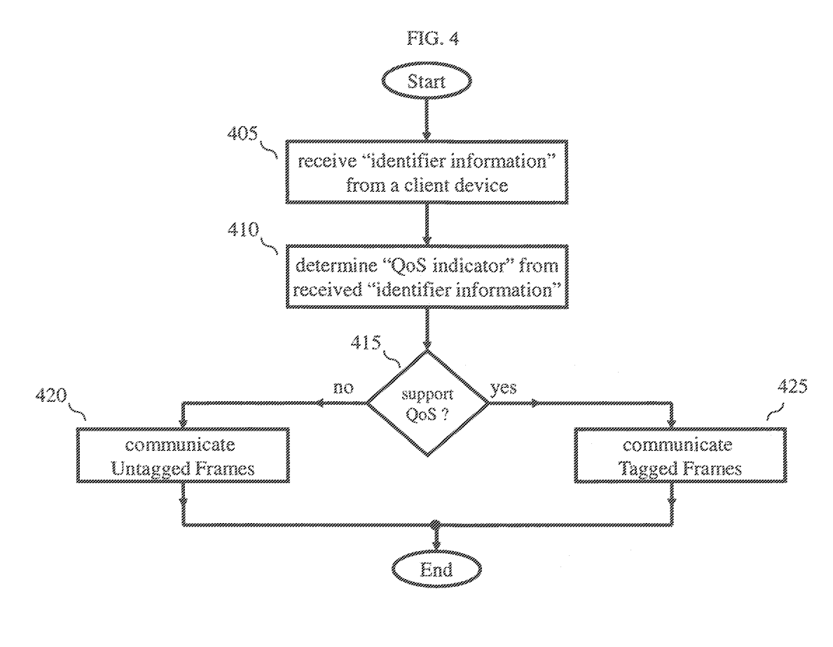

Turning now to FIG. 3, an illustrative embodiment of BHR 10 in accordance with the principles of the invention is shown. Only those portions relevant to the inventive concept are shown. BHR 10 comprises a cable interface 155, a processor 160, a memory 165 and a LAN interface 170. The various elements of BHR 10 are coupled together via signaling as represented by arrows 156, 157 and 166. Cable interface 155 couples BHR 10 to the network cloud (not shown) via a wired, or wireless, connection as represented by arrow 9 for sending and receiving data. Likewise, LAN interface 170 couples BHR 10 to the devices on the local network via wired, or wireless, connections as represented by arrows 11, 12 and 13 for sending and receiving traffic in accordance with the principles of the invention. BHR 10 is a processor-based system and includes one, or more, processors and associated memory as represented by processor 160 and memory 165. In this context, computer programs, or software, (e.g., representing the flow charts of FIG. 4, 5, 9 or 13, below) are stored in memory 165 for execution by processor 160. As noted, processor 160 is representative of one, or more, stored-program control processors and these do not have to be dedicated to any one particular function of BHR 10, e.g., processor 160 may also control other functions of the gateway device. Memory 165 is representative of any storage device, e.g., random-access memory (RAM), read-only memory (ROM), etc.; may be internal and/or external to the gateway device; and is volatile and/or non-volatile as necessary.

An illustrative flow chart in accordance with the principles of the invention for use in BHR 10 is shown in FIG. 4. The flow chart of FIG. 4 is a high-level representation of a method for implementation in BHR 10 of FIG. 2. In step 405, the gateway device receives “identifier information” from a client device when the client device is first connecting to the LAN. In step 410, the gateway device retrieves an associated “QoS indicator” from a table stored in the gateway device as a function of the received “identifier information”. The values for this table can be set in the factory and/or administered by an administrator of the gateway device. In step 415, the gateway device determines from the retrieved “QoS indicator” whether or not the client device supports L2 QoS. If the client device does not support L2 QoS, then the gateway device communicates with the client device using Untagged Frames in step 420. However, if the client device does support L2 QoS, then the gateway device communicates with the client device using Tagged Frames in step 425. In this regard, the gateway device forms an address table associating the MAC address for a client device with the associated frame structure. This, in effect, establishes a set of rules for subsequent communication with each client device. As a result, the gateway device, e.g., BHR 10, dynamically adjusts the packet structure for each client device on the LAN. For those client devices that support L2 QoS treatment, Tagged Frames will be communicated; while for those client devices that do not support L2 QoS treatment, Untagged Frames will be communicated. In other words, BHR 10 manipulates traffic that passes through the gateway to client devices by adding, or not adding, as needed, priority tagging information to the traffic that goes to each client device. It should also be noted that the Internet Protocol (IP) address could be used in the address table instead of the MAC address.

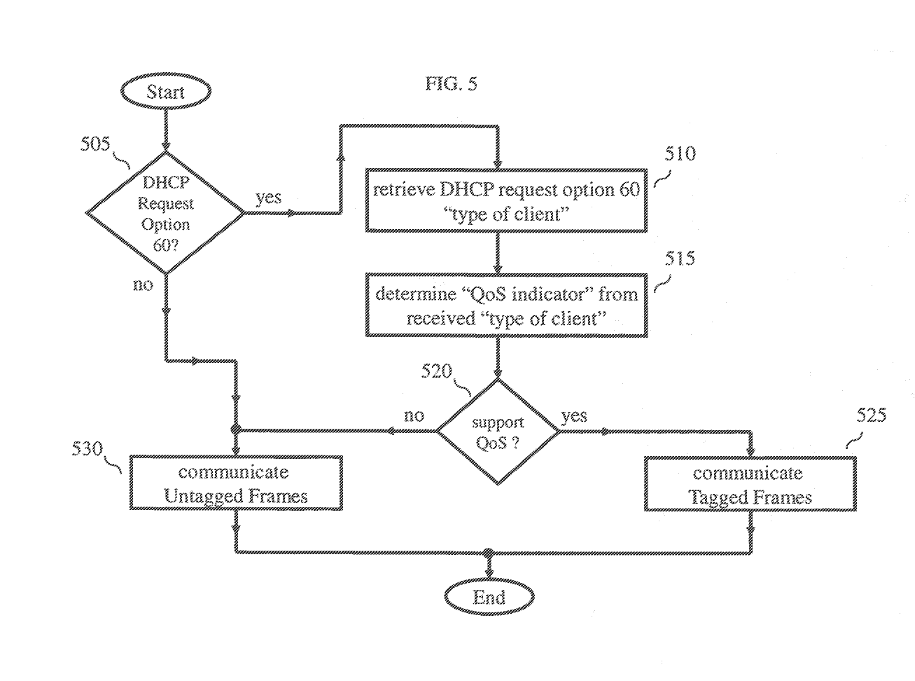

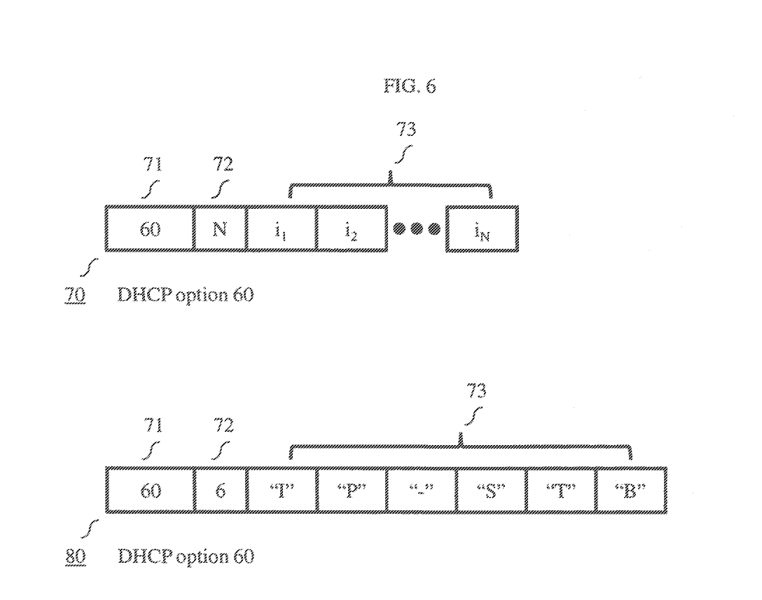

A more specific illustrative embodiment in accordance with the principles of the invention is shown in the flow chart of FIG. 5. Like the flow chart of FIG. 4, the flow chart of FIG. 5 is a representation of a method for implementation in BHR 10 of FIG. 2. In this embodiment, the Dynamic Host Configuration Protocol (DHCP) is used between a gateway device and a client device as a preliminary step in connecting to a network. As such, and in accordance with the principles of the invention, DHCP is used to communicate the “identifier information” from the client device to the gateway device. In this example, the “identifier information” is the “type of client device”. As such, a client device is modified to identify whether, or not, they support L2 QoS via a DHCP option identifier using, e.g., DHCP request option 60. DHCP request option 60 is the “Vendor class identifier”. This option is used by DHCP clients to optionally identify the vendor class type and configuration of a DHCP client. In accordance with the principles of the invention, this may be used to identify L2 QoS support. The format 70 for DHCP request option 60 is shown in FIG. 6. DHCP request option 60 comprises a code field 71, here conveying the octet having a value of 60, which indicates this is DHCP request option 60. Following code field 71 is a length field 72, the value of which indicates the number, N, of octets comprising DHCP request option 60 (the minimum length is one octet). The length field 72 is followed by vendor class identifier 73, comprising N octets of data.

In this example, all set-top boxes in the network of FIG. 2 identify themselves as an “IP-STB” type of client. For example, STB 50 of FIG. 2 is connected to a LAN port on the BHR 10 and is powered on. As STB 50 begins the process of getting an IP address from BHR 10 via DHCP, STB 50 includes a value of “IP-STB” in DHCP request option 60. This is illustrated in format 80 of FIG. 6. (It should be noted that the modification to a client device, e.g., STB 50, PC 40, etc., to use DHCP request option 60 in accordance with the principles of the invention may be implemented using conventional programming techniques, which, as such, are not be described herein.) In format 80, code field 71 conveys the octet having a value of 60, which indicates this is DHCP request option 60. Following code field 71 is length field 72, the value of which is 6, which indicates the number of octets comprising this DHCP request option 60. As such, vendor class identifier 73 comprises 6 octets representing the character string “IP-STB”. This value identifies STB 50 to BHR 10 as a device that not only recognizes the L2 QoS header but also is an indicator to BHR 10 that STB 50 prefers that its traffic always includes the QoS header.

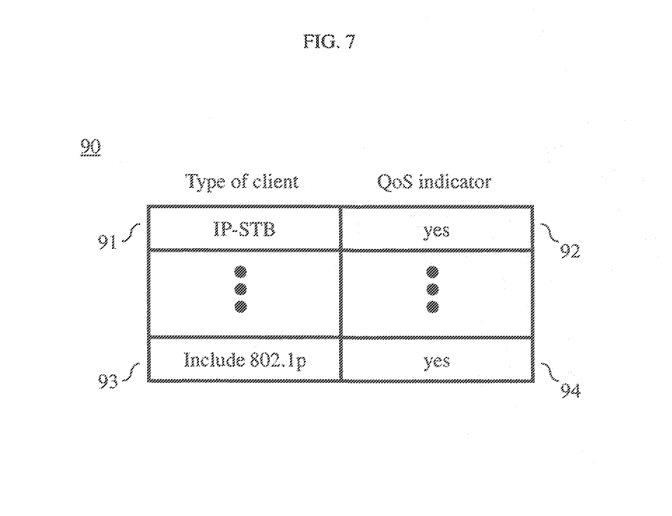

Returning to FIG. 5, when first connecting to a client device, BHR 10 of FIG. 2 determines if a DHCP request option 60 has been received from the client device in step 505. If a DHCP request option 60 has been received, then BHR 10 retrieves the “type of client” from the received DHCP request option 60 in step 510. In step 515, BHR 10 determines an associated “QoS indicator” from a table 90 stored in, e.g., memory 165 of FIG. 3, as a function of the received “type of client” information. An illustrative table 90 is shown in FIG. 7. Table 90 comprises at least one row and two columns. As shown in FIG. 7, table 90 maps each “type of client” to whether, or not, the client device supports L2 QoS. In this example, the type of client “IP-STB” (element 91 of table 90) is associated with supporting QoS as indicated by the “yes” value (element 92 of table 90). The values for table 90 can be set in the factory and/or administered by an administrator of BHR 10 via use of a login and password (e.g., via telnet, SNMP, TR-069, etc.) Returning to FIG. 5, in step 520, BHR 10 determines from the retrieved “QoS indicator” whether or not the client device supports L2 QoS. If the client device does not support L2 QoS, then the gateway device communicates with the client device using Untagged Frames in step 530. However, if the client device does support L2 QoS, e.g., the client device is STB 50 of FIG. 2, then BHR 10 communicates with the client device using Tagged Frames in step 525. This will assure that all traffic that involves STB 50 has priority tag information included, i.e., 802.1Q Field 110 of FIG. 1. It should be noted that in terms of an error condition that if a “type of client” value is received that is not represented in table 90, BHR 10 will default to communicating Untagged Frames (or, alternatively communicating Tagged Frames). In this regard, in step 505, if BHR 10 determines that no DHCP request option 60 has been received, BHR 10 illustratively defaults to communicating Untagged Frames in step 530. For example, assume PC 30 of FIG. 2 does not provide a DHCP request option 60 when connecting to LAN 1. BHR 10 then defaults to determining that PC 30 does not support L2 QoS and BHR 10 communicates with PC 30 using Untagged Frames. As such, all traffic that involves PC 30 will have any priority tag information removed. (Again, it should be noted that alternatively BHR 10 could default to communicating Tagged Frames in step 525 if no DHCP option 60 has been received.)

In accordance with another illustrative embodiment for use in the flow chart of FIG. 5, a single computer, e.g., PC 40, on the network is considered a high priority device and supports L2 QoS treatment. A DHCP request option 60 from PC 40 may include “identifier information” that states “Include 802.1p” (15 octets), identifying PC 40 to BHR 10 as recognizing QoS traffic and wanting priority tag information included in any traffic to PC 40. This is illustrated in table 90 of FIG. 7 by elements 93 and 94. BHR 10 is then able to ensure that all traffic for PC 40 includes 802.1Q Field 110 of FIG. 1. Any other client device that does not include the identifiers “Include 802.1p” or “IP-STB” would have any associated traffic stripped, as needed, of 802.1Q Field 110 in this example.

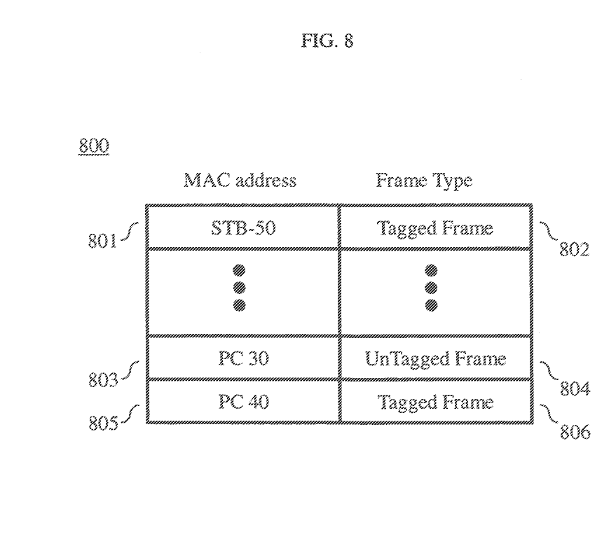

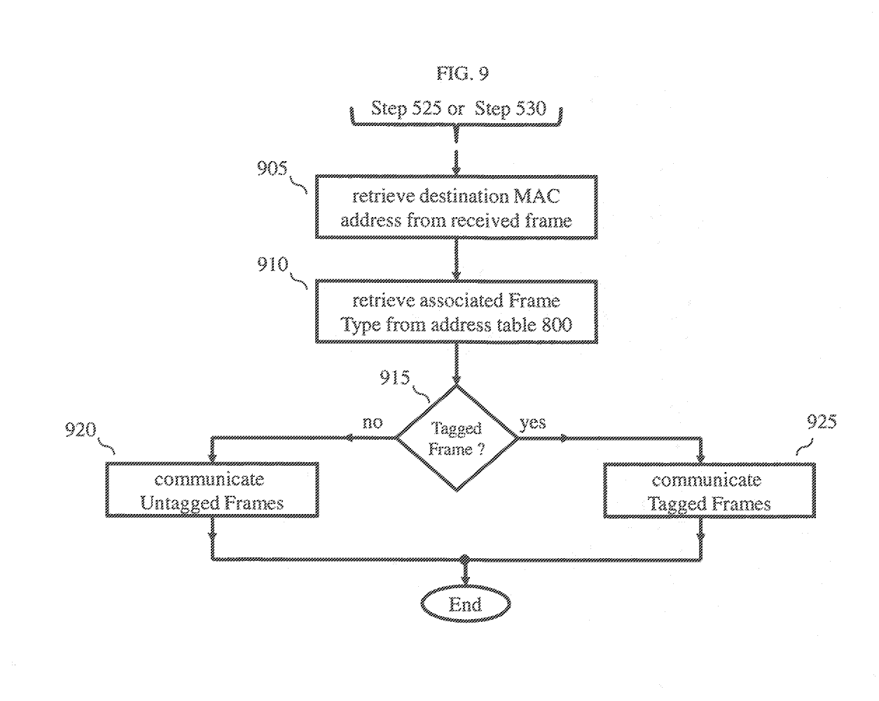

In the context of the above described embodiments, in communicating either Untagged Frames or Tagged Frames to a client device in steps 525 and 530 of FIG. 5, BHR 10 creates and maintains a client address table associating the client MAC address with the type of frame structure in, e.g., memory 165. This is illustrated by address table 800 shown in FIG. 8. (As noted earlier, the IP address could also be used instead of the MAC address). When BHR 10 determines the type of QoS for a client device, as illustrated by steps 505 and 520 of FIG. 5, BHR 10 associates the MAC address of that client device with the desired packet structure. As shown in FIG. 8, in the context of the above-described example, the MAC address of STB 50 (element 801) is associated with Tagged Frames (element 802), while the MAC address of PC 30 (element 803) is associated with Untagged Frames (element 804), and the MAC address of PC 40 (element 805) is associated with Tagged Frames (element 806). This in effect establishes a set of rules for each client device. As such, when packets are destined for LAN clients with the MAC address for STB 50, BHR 10 determines from address table 800 that Tagged Frames are communicated with STB 50. Likewise, when packets are destined for LAN client having the MAC address for PC 30, BHR 10 determines from address table 800 that Untagged Frames are communicated with PC 30. Finally, when packets are destined for LAN client having the MAC address for PC 40, BHR 10 determines from address table 800 that Tagged Frames are communicated with PC 40. In this regard, an illustrative flow chart for communicating with a client device for use in steps 525 and 530, of FIG. 5, is shown in FIG. 9. In step 905, BHR 10 retrieves the destination MAC address for egress packets. In step 910, BHR 10 retrieves the associated Frame Type from address table 800 of FIG. 8. In step 915, BHR 10 determines from the retrieved Frame Type whether, or not, Tagged Frames, or Untagged Frames, should be sent to the client device associated with the destination MAC address. If Untagged Frames should be sent to the client device, then BHR 10 communicates with the client device using Untagged Frames in step 920. However, if Tagged Frames should be sent to the client device, then BHR 10 communicates with the client device using Tagged Frames in step 925.

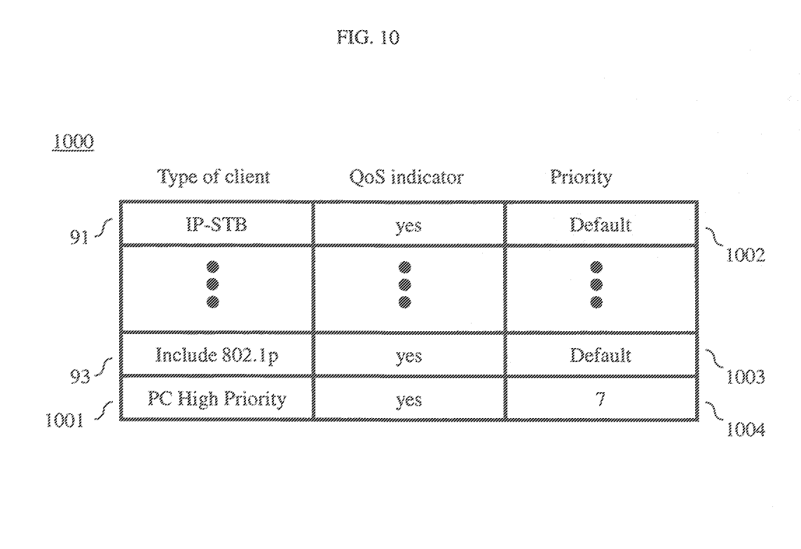

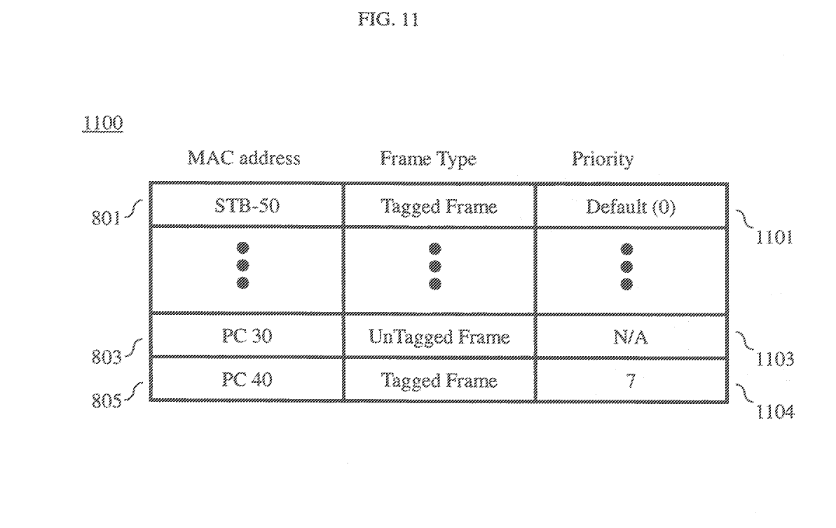

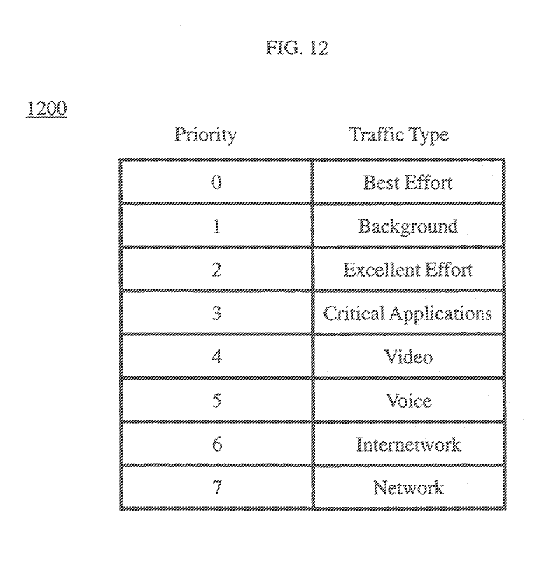

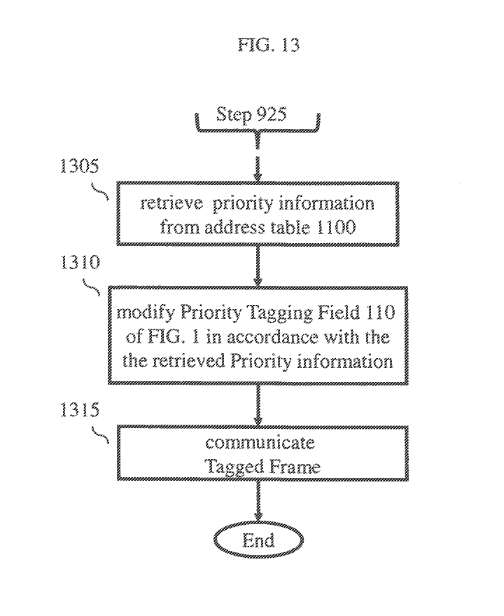

In accordance with another illustrative embodiment in accordance with the principles of the invention, the same mechanisms can be used to apply variable priority tags to traffic related to different devices. In addition to being able to dynamically provide Untagged Frames or Tagged Frames to client devices, when Tagged Frames are provided by the gateway device, the gateway device, e.g., BHR 10, automatically prioritizes traffic for those specific devices that support L2 QoS. In this example, table 90 of FIG. 7 is modified to add an additional column related to the Priority of the traffic. This is illustrated in FIG. 10 by table 1000. Like table 90, table 1000 includes columns for the “type of client” and the associated “QoS indicator” as described earlier. In addition, table 1000 includes “Priority information” for when the client device supports L2 QoS. The values for table 1000 can be set in the factory and/or administered by an administrator of BHR 10 via use of a login and password (e.g., via telnet, SNMP, TR-069, etc.) In the context of the above-described examples, STB 50 of FIG. 2 connects to the LAN with a value of “IP-STB” in DHCP request option 60 as described earlier. The associated “Priority” value for “IP-STB” is “Default”, e.g., a value of 0 (also referred to a “Best Effort”) (element 1002), as such BHR 10 leaves all traffic involving STB 50 tagged with the priority value provided by the source of the packet. In other words, BHR 10 does not modify 802.1Q field 110 of any Tagged Frames. A similar “Default” (element 1003) result would occur for any client device with a value of “Include 802.1p” in DHCP request option 60 as described earlier. However, a computer, e.g., PC 40 of FIG. 2, now connects to the LAN 1 with a value of “PC-High priority” in DHCP request option 60. In this case, BHR 10 modifies the 802.1Q Field 110 802.1p bits to a value of “7” (element 1001 and element 1004), which represents the highest network priority for all traffic involving PC 40. Similarly, if PC 30 connects with no value in DHCP request option 60 then, as described earlier, BHR 10 will communicate Untagged Frames for all traffic destined for PC 30. It should also be noted that for this example the address table 800 is similarly modified to now include priority information for the associated MAC address of the client device. This is illustrated by address table 1100 of FIG. 11. Address table 1100 is similar to address table 800 of FIG. 8 except that priority information has been added for each client device as shown in FIG. 8 so that BHR 10 can determine from the MAC address of egress packets what the appropriate packet structure is, and, if Tagged Frames are being communicated, whether 802.1Q Field 110 802.1p bits are accordingly modified, or not, by BHR 10 (elements 1101, 1103 and 1104). Again, this is another illustration of a set of rules for each client device. From address table 1100 it can be observed that for PC 30 since Untagged Frames are communicated, the priority information is not applicable (N/A) (element 1103). Finally, other illustrative priority values can be used to automatically prioritize traffic as shown in table 1200 of FIG. 12, the values of which are defined in accordance with IEEE 802.1Q (e.g., see table G-2) and not described further herein. An illustrative flow chart for use, e.g., in step 925 of FIG. 9, in applying variable priority tags to traffic for a client device is shown in FIG. 13. In step 1305, BHR 10 retrieves the associated priority information for the egress packet MAC address from address table 1100. In step 1310, BHR 10 modifies 802.1Q Field 110 of FIG. 1 in accordance with the retrieved priority information. It should be noted, and as described above, that in some cases, e.g., for a “default” priority BHR 10 leaves all traffic involving STB 50 tagged with the priority value provided by the source of the packet. Finally, in step 1315, BHR 10 communicates the

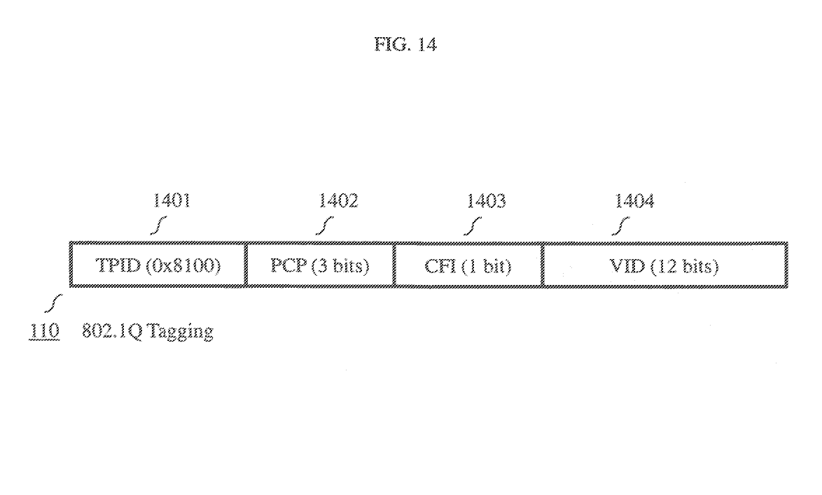

Tagged Frame with the modified Priority Tagging field to the client device identified by the destination MAC address. Referring briefly to FIG. 14, the format for 802.1Q Tagging field 110 is shown. 802.1Q Tagging field 110 comprises TPID (Tag Protocol Identifier) field 1401, which is set to a value of 0x8100 (two bytes). In addition, 802.1Q Tagging field 110 comprises the 802.1p bits noted above. The 802.1p bits are represented by PCP (Priority Code Point) field 1402 (three bits). The 802.1p bits (PCP field 1402) are the field modified by the illustrative method of FIG. 13, described above. 802.1Q Tagging field 110 also comprises CFI (Canonical Format Indicator) field 1403 (1 bit) and VID (VLAN Identifier) field 1404 (12 bits).

As described above, and in accordance with the principles of the invention, a gateway device dynamically adjusts the packet structure used in communicating with client devices as a function of the ability of each client device to support L2 QoS. For example, a gateway device can now provide packets with a Tagged Frame structure for communicating video to one client device while also providing an Untagged Frame structure for communicating data to a second client device that does not support L2 QoS. Further, a gateway device can automatically prioritize traffic by modification of the 802.1p field in the 802.1Q header 110 in a Tagged Frame 150 in accordance with associated priority information for each client device.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, e.g., LAN interface 170, any or all of the elements may be implemented in a stored-program-controlled processor, e.g., a digital signal processor, which executes associated software, e.g., corresponding to one, or more, of steps. It is therefore to be understood that numerous modifications may be made to the illustrative embodiments and that other arrangements may be devised without departing from the spirit and scope of the present invention.

1. A method for use in a gateway device, the method comprising:
communicating with a client device on a local area network for determining whether, or not, Layer 2 Quality of Service treatment is supported by the client device; and
adjusting a frame size subsequently communicated with the client device in accordance with the determined Quality of Service treatment.

2. The method of claim 1, wherein the adjusting step includes the steps of:
if the client device does not support L2 Quality of Service treatment, subsequently communicating the frame without priority tagging information with the client device; and
if the client device does support L2 Quality of Service treatment, subsequently communicating the frame with priority tagging information with the client device.

3. The method of claim 2, wherein the frame without priority tagging information is an Untagged Frame as defined in accordance with IEEE 802.3 and the frame with priority tagging information is a Tagged Frame as defined in accordance with IEEE 802.1Q.

4. The method of claim 1, wherein the communicating step includes the steps of:
connecting to the client device on the local area network;
receiving identifier information from the client device; and
determining from the received identifier information whether or not the client device supports L2 Quality of Service treatment.

5. The method of claim 4, wherein if no identifier information is received from the client device, then determining that the client device does not support L2 Quality of Service treatment.

6. The method of claim 4, wherein if no identifier information is received from the client device, then determining that the client device does support L2 Quality of Service treatment.

7. The method of claim 4, wherein the received identifier information is communicated via a dynamic host configuration protocol (DHCP) request from the client device

8. The method of claim 7, wherein the DHCP request is DHCP request option 60.

9. The method of claim 4, further comprising the step of:
forming an address table associating an address of the client device with the determined type of quality of service treatment.

10. The method of claim 9, wherein the adjusting step communicates with the client device in accordance with the quality of service treatment associated with the address of the client device from the address table.

11. The method of claim 9, wherein the address is a Media Access Control address of the client device or an Internet Protocol (IP) address of the client device.

12. The method of claim 4, wherein the determining step includes the step of:
determining from the received identifier information a priority tag associated with the client device.

13. The method of claim 12, wherein the adjusting step includes the step of:
modifying, as needed, priority tagging information in accordance with the determined priority tag when subsequently communicating frames with the client device.

14. The method of claim 12, further comprising the step of:
forming an address table associating an address of the client device with the determined type of quality of service treatment and the determined priority tag for use in subsequently communicating frames with the client device.

15. A gateway apparatus comprising:
a local area network interface for communicating frames with a client device; and
a processor for adjusting the frame size used by the local area network interface to communicate frames with the client device, wherein the adjusted frame size is determined in accordance with a determined Quality of Service treatment supported by the client device.

16. The gateway apparatus of claim 15, wherein if the client device does not support L2 Quality of Service treatment, the processor adjusts the frame size to not include priority tagging information with the client device; and
if the client device does support L2 Quality of Service treatment, the processor adjusts the frame size to include priority tagging information with the client device.

17. The gateway apparatus of claim 16, wherein a frame that does not include priority tagging information is an Untagged Frame as defined in accordance with IEEE 802.3 and frame that does include priority tagging information is a Tagged Frame as defined in accordance with IEEE 802.3ac.

18. The gateway apparatus of claim 15, wherein the processor determines the Quality of Service treatment for the client device by receiving identifier information from the local area network interface when connecting to the client device on the local area network.

19. The gateway apparatus of claim 18, wherein if no identifier information is received from the client device, the processor determines that the client device does not support L2 Quality of Service treatment.

20. The gateway apparatus of claim 18, wherein if no identifier information is received from the client device, the processor determines that the client device does support L2 Quality of Service treatment.

21. The gateway apparatus of claim 18, wherein the received identifier information is communicated via a dynamic host configuration protocol (DHCP) request from the client device.

22. The gateway apparatus of claim 21, wherein the DHCP request is DHCP request option 60.

23. The gateway apparatus of claim 18, wherein the processor forms an address table associating an address of the client device with the determined type of quality of service treatment.

24. The gateway apparatus of claim 23, wherein the processor adjusts the frame size with the client device in accordance with the quality of service treatment associated with the address of the client device from the address table.

25. The gateway apparatus of claim 24, wherein the address is a Media Access Control address of the client device or an Internet Protocol address of the client device.

26. The gateway apparatus of claim 15, wherein the processor determines the Quality of Service treatment and a priority tag for the client device by receiving identifier information from the local area network interface when connecting to the client device on the local area network.

27. The gateway apparatus of claim 26, wherein the processor adjusts the frame size and modifies, as needed, priority tagging information of the frame in accordance with the determined priority tag when subsequently communicating with the client device.

28. The gateway apparatus of claim 26, wherein the processor forms an address table associating an address of the client device with the determined type of quality of service treatment and the determined priority tag for use in subsequently communicating frames with the client device.
